(19) United States
(12) Patent Application Publication
(10) Pub. No.: US 2015/0341112 A1
(43) Pub. Date: Nov. 26, 2015

(54) COMMUNICATION LIGHT DETECTING OPTICAL MODULE AND COMMUNICATION LIGHT DETECTING STRUCTURE

(71) Applicant: Hitachi Metals, Ltd., Tokyo (JP)

(72) Inventor: Kanako SUZUKI, Tsukuba (JP)

(21) Appl. No.: 14/716,932

(22) Filed: May 20, 2015

(30) Foreign Application Priority Data
May 21, 2014 (JP) 2014-105291

(51) Int. Cl. H04B 10/079; G02B 6/38; G02B 6/44

(52) U.S. Cl. CPC H04B 10/0799; G02B 6/4495; G02B 6/3889

(57) ABSTRACT

A communication light detecting optical module includes a plurality of optical transmission lines each including a light drawing portion to draw a leak portion of communication light being transmitted in the each of the plurality of optical transmission lines as a leaky light, and a multifiber connector with the plurality of optical transmission lines being arranged side by side, inserted and fixed therein. The multifiber connector includes an adhesive filled portion exposing the plurality of optical transmission lines and being filled with an adhesive to fix the plurality of optical transmission lines. The plurality of optical transmission lines are being inserted and fixed in the multifiber connector in such a manner that the light drawing portions are being arranged in the adhesive filled portion.

The present application is based on Japanese patent application No. 2014-105291 filed on May 21, 2014, the entire contents of which are incorporated herein by reference.

### BACKGROUND OF THE INVENTION

1. Field of the Invention

This invention relates to a communication light detecting optical module and a communication light detecting structure for detecting communication light to visually identify a use/non-use state of an optical transmission line.

2. Description of the Related Art

In optical communication (light communication)-related facilities, in order to monitor the soundness of an optical transmission line or prevent human erroneous detaching of a connector, a communication light detecting technique for detecting communication light in an invisible light region to identify a use/non-use state (hereinafter referred to as “communication state”) of the optical transmission line has been known.

As a concrete example of this communication light detecting technique, a communication light detecting structure is known that draws a leaky portion of the communication light being transmitted in the optical transmission line as a leaky light, receives the leaky light of the communication light in a light receiving element, thereby detects whether the communication light is being transmitted in the optical transmission line or not, and outputs the communication state of the optical transmission line in such a form that humans can visually identify it (Refer to e.g. JP-A-2009-145676, JP-A-2010-231082, JP-A-2011-013359, and JP-A-2011-013360).

As shown in FIG. 4, a communication light detecting structure 400 includes a communication light detecting optical module 406 comprising an optical transmission line 404 including a light drawing portion 403 to draw a leaky light 402 of communication light 401, and a single fiber connector 405 made of a light-scattering material for the optical transmission line 404 being inserted and fixed therein so as to scatter the leaky light 402 of the communication light 401 in all directions, a communication light detector 408 including a light receiving element 407 configured to receive the leaky light 402 of the communication light 401, and a communication light detecting adapter 410 with the single fiber connector 405 inserted therethrough, and with a light drawing hole 409 formed thereon for the leaky light 402 of the communication light 401 to be drawn therethrough toward the light receiving element 407.

Refer to JP-A-2009-145676, JP-A-2010-231082, JP-A-2011-013359, JP-A-2011-013360, and JP-A-2013-228678, for example.

### SUMMARY OF THE INVENTION

However, the single fiber connector 405 is unsuitable for high density optical transmission line mounting resulting from the information capacity increasing in recent years. Therefore, the appearance of a communication light detecting optical module, which has a multifiber connector instead of the single fiber connector 405, thereby identifies the respective communication states of a plurality of optical transmission lines, has been awaited.

Accordingly, it is an object of the present invention to provide a communication light detecting optical module and a communication light detecting structure, which have a multifiber connector, allowing for identifying the respective communication states of a plurality of optical transmission lines.

(1) According to one embodiment of the invention, a communication light detecting optical module comprises:

a plurality of optical transmission lines each including a light drawing portion configured to draw a leaky portion of communication light being transmitted in the each of the plurality of optical transmission lines as a leaky light; and

a multifiber connector with the plurality of optical transmission lines being arranged side by side, inserted and fixed therein, the multifiber connector including an adhesive filled portion exposing the plurality of optical transmission lines and being filled with an adhesive to fix the plurality of optical transmission lines, the plurality of optical transmission lines being inserted and fixed in the multifiber connector in such a manner that the light drawing portions are being arranged in the adhesive filled portion.

In one embodiment, the following modifications and changes may be made.

(i) The plurality of optical transmission lines are being inserted and fixed in the multifiber connector in such a manner that the light drawing portions are being arranged at different locations from one another in a longitudinal direction thereof.

(ii) The adhesive is translucent to the leaky light of the communication light.

(iii) The adhesive comprises a thermoset resin or a light curable resin.

(2) According to another embodiment of the invention, a communication light detecting structure comprises:

the communication light detecting optical module as specified in (1), and

a communication light detector including a light receiving element configured to receive the leaky light of the communication light.

In another embodiment, the following modifications and changes may be made.

The communication light detector includes a light receiving element array including a plurality of the light receiving elements arranged in one-to-one correspondence with the light drawing portions of the plurality of optical transmission lines, respectively.

(Points of the Invention)

The invention can provide the communication light detecting optical module and the communication light detecting structure, which have the multifiber connector, allowing for identifying the communication states of the plurality of optical transmission lines.

### BRIEF DESCRIPTION OF THE DRAWINGS

The preferred embodiment according to the invention will be explained below referring to the drawings, wherein:

FIG. 1 is a schematic perspective view showing a communication light detecting optical module according to the invention;

FIG. 2 is a schematic plan view showing the communication light detecting optical module according to the invention;

FIG. 3 is a schematic cross sectional view showing the communication light detecting structure according to the invention; and

FIG. 4 is a schematic cross sectional view showing a conventional communication light detecting structure.

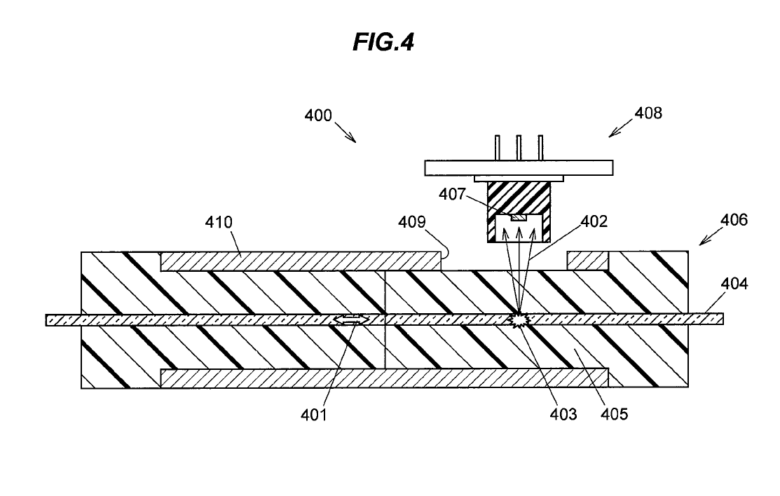

### DETAILED DESCRIPTION OF THE PREFERRED EMBODIMENT

Next, a preferred embodiment according to the invention will be explained in conjunction with the accompanying drawings.

First, a communication light detecting optical module is described.

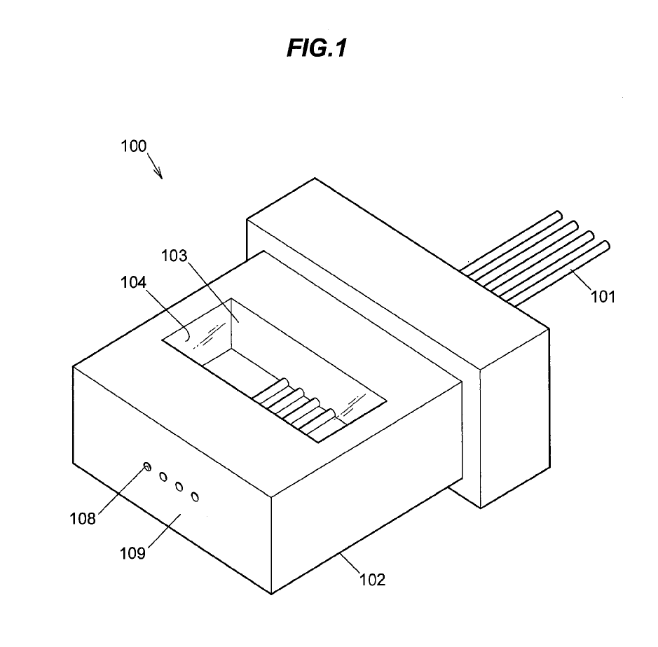

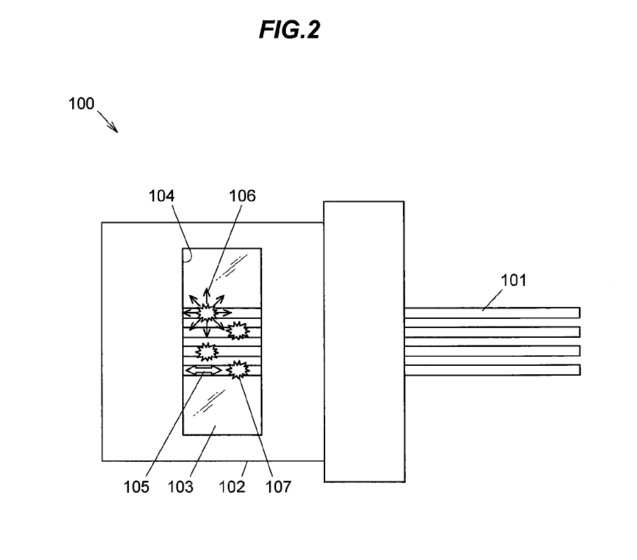

As shown in FIGS. 1 and 2, a communication light detecting optical module 100 in the preferred embodiment of the present invention comprises a plurality of optical transmission lines 101, and a multifiber connector 102 with the plurality of optical transmission lines 101 being arranged side by side, inserted and fixed therein. The multifiber connector 102 includes an adhesive filled portion 104 exposing the plurality of optical transmission lines 101 and being filled with an adhesive 103 to fix the plurality of optical transmission lines 101.

Each of the plurality of optical transmission lines 101 is made of e.g. an optical fiber, and includes a light drawing portion 107 to draw a leak portion of communication light 105 being transmitted in the each of the plurality of optical transmission lines 101 as a leaky light 106. The plurality of optical transmission lines 101 are inserted in the multifiber connector 102 in such a manner that the light drawing portions 107 are arranged in the adhesive filled portion 104.

At this point, it is desirable that the plurality of optical transmission lines 101 are inserted in the multifiber connector 102 in such a manner that the light drawing portions 107 are arranged at different locations from one another in a longitudinal direction thereof. For example, the light drawing portions 107 of the plurality of optical transmission lines 101 are staggered (arranged in a zigzag) in plan view.

This allows for widening the pitch between the light drawing portions 107 adjacent to each other, as compared to when the plurality of optical transmission lines 101 are inserted in the multifiber connector 102 in such a manner that the light drawing portions 107 are arranged at the same locations as each other in the longitudinal direction.

As a result, it is possible to clearly distinguish between a leaky light 106 of communication light 105 drawn at a particular light drawing portion 107 and a leaky light 106 of communication light 105 drawn at another light drawing portion 107, selectively receive only the leaky light 106 drawn at that particular light drawing portion 107 in a light receiving element, and securely identify only the communication state of that particular optical transmission line 101.

Although herein it is described that the plurality of optical transmission lines 101 are made of separate optical fibers, the plurality of optical transmission lines 101 may be replaced by an optical fiber ribbon composed of a plurality of optical fibers bound together.

This allows for enhancing the handling of the plurality of optical transmission lines 101, and enhancing the workability when the plurality of optical transmission lines 101 are inserted and fixed in the multifiber connector 102, as compared with when the plurality of optical transmission lines 101 are made of separate optical fibers.

It should be noted that, as the light drawing portion 107, it is possible to employ a known structure, such as a light detecting groove as disclosed in the above-listed JP-A-2009-145676, JP-A-2010-231082, or JP-A-2011-013359, or an axially misaligned portion as disclosed in the above-listed JP-A-2013-228678, but its detailed description is omitted herein.

The multifiber connector 102 is made of e.g. a versatile MT connector molded using a resin molding technique, and includes a plurality of inserting holes 108, which are arranged side by side at a predetermined pitch for the plurality of optical transmission lines 101 respectively to be inserted therein.

After the plurality of optical transmission lines 101 are inserted in the plurality of inserting holes 108 respectively, the adhesive filled portion 104 is formed by filling with the adhesive 103, so that capillary action permeates the adhesive 103 through the inserting holes 108 over substantially entire lengths of the inserting holes 108, allowing the plurality of optical transmission lines 101 to be securely fixed in the plurality of inserting holes 108 respectively over the substantially entire lengths of the plurality of inserting holes 108.

The adhesive 103 is required to be translucent to the leaky light 106. This is because if the adhesive 103 is opaque to the leaky light 106, the leaky light 106 is confined in the adhesive filled portion 104, and cannot be received in the light receiving element.

Also, it is desirable that the adhesive 103 is made of a thermoset resin or a light curable resin. This is because the thermoset resin or light curable resin is fast-hardening and excellent to handle, leading to enhancement in productivity of the communication light detecting optical module 100.

Moreover, as the adhesive 103, it is desirable to use an adhesive having a high light transmittance, a high hardness after curing, and a low viscosity before curing.

A reason for the use of the adhesive 103 having a high light transmittance is because the use of the high light transmittance adhesive 103 allows reduction in light loss when the leaky light 106 passes through the adhesive 103, and thereby makes it possible to identify the communication state of the optical transmission line 101 with high precision.

Also, a reason for the use of the adhesive 103 having a high hardness after curing is because when after the plurality of optical transmission lines 101 are arranged side by side, inserted and fixed in the multifiber connector 102, an end face of the multifiber connector 102 is polished to produce an even optical connecting surface 109, if the hardness of the cured adhesive 103 is low, the adhesive 103 is likely to be eliminated by that polishing.

Further, a reason for the use of the adhesive 103 having a low viscosity before curing is because the use of the adhesive 103 having a low viscosity before curing allows the fast permeation of the adhesive 103 through the inserting holes 108, and thereby makes it possible to shorten the time required to fix each of the plurality of optical transmission lines 101 to the multifiber connector 102.

In addition, there may also be used the adhesive 103 made of a light-scattering material. In this case, the leaky light 106 is likely to be scattered in all directions in the adhesive 103. This makes it difficult to clearly distinguish between a leaky light 106 of communication light 105 drawn at a particular light drawing portion 107 and a leaky light 106 of communication light 105 drawn at another light drawing portion 107, and makes it impossible to selectively identify only the communication state of that particular optical transmission line 101.

From the point of view of preventing the human erroneous detaching of the multifiber connector 102, however, there is no need to identify the optical transmission line 101 with the communication light 105 being transmitted therein, and it suffices to be able to detect whether or not the communication light 105 is being transmitted in at least one optical transmission line 101. The use of the adhesive 103 made of a light-scattering material is therefore not excluded.

A communication light detecting structure will be explained next.

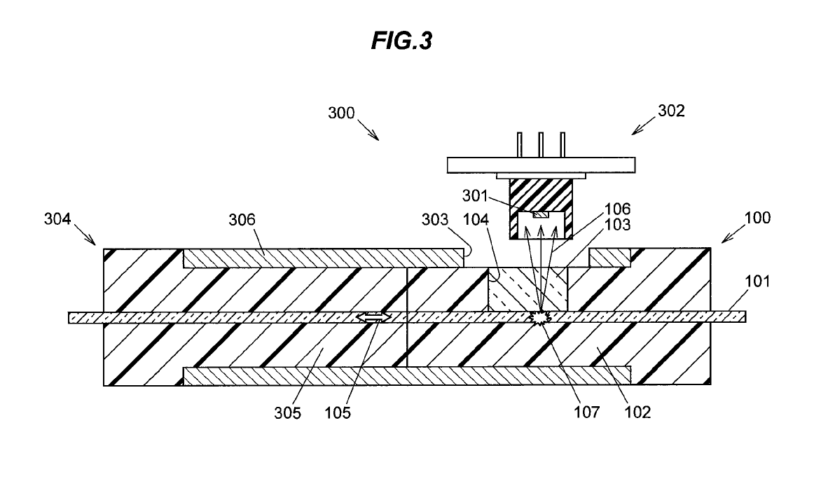

As shown in FIG. 3, a communication light detecting structure 300 in a preferred embodiment of the present invention comprises a communication light detecting optical module 100, and a communication light detector 302 including a light receiving element 301 to receive the leaky light 106.

The communication light detecting optical module 100 is optically connected with another optical module 304 via a communication light detecting adapter 306 with a multifiber connector 305 of the other optical module 304 inserted therethrough, and with a light drawing hole 303 formed thereon for the leaky light 106 to be drawn therethrough toward the light receiving element 301.

It is desirable that the communication light detector 302 includes a light receiving element array composed of a plurality of the light receiving elements 301 arranged in one-to-one correspondence with the light drawing portions 107, respectively.

This allows for identifying the communication states of the plurality of optical transmission lines 101 together, and thereby greatly saving the time and labor required to identify the communication states of the optical transmission lines 101.

As described so far, the communication light detecting optical module 100 according to the present invention comprises the plurality of optical transmission lines 101, each of which includes its own light drawing portion 107 to draw the leaky light 106 of the communication light 105 being transmitted in the each of the plurality of optical transmission lines 101, and the plurality of optical transmission lines 101 are being inserted in the multifiber connector 102 in such a manner that the light drawing portions 107 are being arranged in the adhesive filled portion 104. It is therefore possible to identify the respective communication states of the plurality of optical transmission lines 101.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A communication light detecting optical module, comprising:
a plurality of optical transmission lines each including a light drawing portion configured to draw a leak portion of communication light being transmitted in the each of the plurality of optical transmission lines as a leaky light; and
a multifiber connector with the plurality of optical transmission lines being arranged side by side, inserted and fixed therein, the multifiber connector including an adhesive filled portion exposing the plurality of optical transmission lines and being filled with an adhesive to fix the plurality of optical transmission lines, the plurality of optical transmission lines being inserted and fixed in the multifiber connector in such a manner that the light drawing portions are being arranged in the adhesive filled portion.

2. The communication light detecting optical module according to claim 1, wherein the plurality of optical transmission lines are being inserted and fixed in the multifiber connector in such a manner that the light drawing portions are being arranged at different locations from one another in a longitudinal direction thereof.

3. The communication light detecting optical module according to claim 1, wherein the adhesive is translucent to the leaky light of the communication light.

4. The communication light detecting optical module according to claim 1, wherein the adhesive comprises a thermoset resin or a light curable resin.

5. A communication light detecting structure, comprising:
the communication light detecting optical module according to claim 1, and
a communication light detector including a light receiving element configured to receive the leaky light of the communication light.

6. The communication light detecting structure according to claim 5, wherein the communication light detector includes a light receiving element array composed of a plurality of the light receiving elements arranged in one-to-one correspondence with the light drawing portions of the plurality of optical transmission lines, respectively.
